(19) United States
(12) Patent Application Publication
(10) Pub. No.: US 2011/0122547 A1
(43) Pub. Date: May 26, 2011

(54) ELECTROLYTIC CAPACITOR AND MANUFACTURING METHOD THEREOF

(75) Inventor: Kazumasa Fujimoto, Saga-shi (JP)

(73) Assignees: SANYO ELECTRIC CO., LTD., Osaka (JP); SAGA SANYO INDUSTRIES CO., LTD., Kishima-gun (JP)

(21) Appl. No.: 12/946,955

(22) Filed: Nov. 16, 2010

(30) Foreign Application Priority Data
Nov. 26, 2009 (JP) 2009-268747

(51) Int. Cl. H01G 9/04; H01G 7/00

(52) U.S. Cl. 361/530; 29/25.41

(57) ABSTRACT

An electrolytic capacitor includes a capacitor element configured by winding an anode chemical conversion foil and a facing cathode foil with no separator interposed therebetween, wherein a first solid electrolyte layer is formed on at least one of facing surfaces of the anode chemical conversion foil and the facing cathode foil, among surfaces of the anode chemical conversion foil and surfaces of the facing cathode foil, concaves and convexes are formed in a main surface of the first solid electrolyte layer, and an electrolyte solution or a second solid electrolyte layer containing a conductive polymer is formed in an interspace formed between the anode chemical conversion foil and the facing cathode foil by the concaves and convexes. An electrolyte having desired characteristics can be formed in the interspace obtained by the concaves and convexes.

This nonprovisional application is based on Japanese Patent Application No. 2009-268747 filed on Nov. 26, 2009 with the Japan Patent Office, the entire contents of which are hereby incorporated by reference.

### BACKGROUND OF THE INVENTION

1. Field of the Invention

The present invention relates to an electrolytic capacitor and a manufacturing method thereof, and in particular to an electrolytic capacitor including a capacitor element configured by winding an anode chemical conversion foil and a facing cathode foil with no separator interposed therebetween, and a manufacturing method thereof.

2. Description of the Related Art

International Publication No. 2008/062604 discloses a wound-type electrolytic capacitor having no separator, including an anode chemical conversion foil and a facing cathode foil wound together with the anode chemical conversion foil. A separator is, for example, manila paper, craft paper, synthetic fiber paper, synthetic fiber nonwoven fabric, or glass paper.

The above wound-type electrolytic capacitor is manufactured as described below. Firstly, to obtain the anode chemical conversion foil, a surface of an aluminum foil is roughened by etching or the like. The roughened surface is subjected to chemical conversion treatment. A dielectric oxide film is formed on the roughened surface. Then, a surface of the dielectric oxide film is coated with a conductive polymer. Thereby, the anode chemical conversion foil is obtained.

The facing cathode foil can be obtained as with the anode chemical conversion foil. A surface of an aluminum foil constituting the facing cathode foil may not be subjected to etching or chemical conversion treatment. The surface of the aluminum foil constituting the facing cathode foil may not be coated with a conductive polymer.

The anode chemical conversion foil and the facing cathode foil obtained as described above are wound with no separator interposed therebetween (i.e., without using a separator). A capacitor element is configured by the winding. The capacitor element is subjected to chemical conversion treatment of a cut section and heat treatment. Then, an electrolyte is formed inside the capacitor element. The capacitor element is impregnated with 3,4-ethylenedioxythiophene as a monomer and a ferric p-toluenesulfonic acid alcohol solution as an oxidant, as a polymerization solution. As a result of chemical polymerization, a conductive polymer layer as the electrolyte is formed between the anode chemical conversion foil and the facing cathode foil.

A sealing rubber is inserted to cause leads of the capacitor element, in which the electrolyte (conductive polymer layer) is formed between the anode chemical conversion foil and the facing cathode foil, to pass therethrough. After the capacitor element is housed in an aluminum case, pressing in a lateral direction and curling are performed on an opening of the aluminum case. Then, aging treatment is performed. A plastic seat plate is inserted onto a curled surface formed in the aluminum case. To form electrode terminals, pressing and bending are performed on the leads. The electrolytic capacitor is thus manufactured.

The electrolytic capacitor obtained as described above can ensure electrical insulation between an anode and a cathode even though it has no separator. The electrolytic capacitor has a capacity and a leak current substantially equal to those of an electrolytic capacitor including a separator.

Japanese Patent Laying-Open No. 2006-186248 discloses a solid electrolytic capacitor element having a separator. The solid electrolytic capacitor element has a foil-wound body. The foil-wound body is configured by winding an anode chemical conversion foil and a facing cathode foil with a separator interposed therebetween. The foil-wound body is impregnated with an electrolyte material made of a conductive polymer.

Japanese Patent Laying-Open No. 2006-186248 also discloses a manner that a plurality of grooves are formed in each of the anode chemical conversion foil and the facing cathode foil. The plurality of grooves extend in a width direction of the anode chemical conversion foil and the facing cathode foil, and are spaced from each other at a predetermined interval in a longitudinal direction of the anode chemical conversion foil and the facing cathode foil. Since the plurality of grooves are formed therein, each of the anode chemical conversion foil and the facing cathode foil has one surface having convexes and the other surface having concaves.

### SUMMARY OF THE INVENTION

As described above, International Publication No. 2008/062604 describes that a capacitor element is configured by winding an anode chemical conversion foil and a facing cathode foil, and an electrolyte is formed by impregnating the capacitor element with a predetermined solution.

Since there is no separator between the anode chemical conversion foil and the facing cathode foil in the capacitor element, an interspace between the anode chemical conversion foil and the facing cathode foil is extremely small in a state where the anode chemical conversion foil and the facing cathode foil are wound. In other words, a conductive polymer formed on a surface of the anode chemical conversion foil substantially tightly adheres to a surface of the facing cathode foil (or a conductive polymer formed on the surface of the facing cathode foil). Even if the capacitor element is impregnated with a predetermined solution, the solution cannot fully penetrate (or be supplied) into the interspace between the anode chemical conversion foil and the facing cathode foil. The capacitor element has a problem that an electrolyte having desired characteristics cannot be formed between the anode chemical conversion foil and the facing cathode foil.

As described above, Japanese Patent Laying-Open No. 2006-186248 describes forming an electrolytic capacitor (capacitor element) by winding an anode chemical conversion foil, a facing cathode foil, and a separator. A plurality of grooves are formed in each of the anode chemical conversion foil and the facing cathode foil. By forming the plurality of grooves, the electrolytic capacitor ensures an interspace between the anode chemical conversion foil and the facing cathode foil. However, the electrolytic capacitor has an increased volume due to the thickness of the separator and the height (depth) of the plurality of grooves formed in each of the anode chemical conversion foil and the facing cathode foil.

One object of the present invention is to provide an electrolytic capacitor including a capacitor element configured by winding an anode chemical conversion foil and a facing cathode foil with no separator interposed therebetween, in which an electrolyte having desired characteristics can be formed in an interspace formed between the anode chemical conversion foil and the facing cathode foil, and a manufacturing method thereof.

An electrolytic capacitor in accordance with the present invention includes a capacitor element. The capacitor element is configured by winding an anode chemical conversion foil and a facing cathode foil with no separator interposed therebetween. A first solid electrolyte layer is formed on at least one of surfaces of the anode chemical conversion foil and the facing cathode foil that face each other. Concaves and convexes are formed in a main surface of the first solid electrolyte layer. An interspace formed between the anode chemical conversion foil the facing cathode foil by the concaves and convexes is filled with an electrolyte solution, or filled with a second solid electrolyte layer containing a conductive polymer.

Preferably, in the electrolytic capacitor described above, the first solid electrolyte layer has a thickness of not less than 0.1 μm.

Preferably, in the electrolytic capacitor described above, a ratio of a depth of a concave to a thickness of a convex in the concaves and convexes is not less than 0.05 and not more than 0.9.

Preferably, in the electrolytic capacitor described above, the concaves and convexes are formed all over the main surface of the first solid electrolyte layer.

A method of manufacturing an electrolytic capacitor in accordance with the present invention includes the steps described below. An anode chemical conversion foil and a facing cathode foil are prepared. A first solid electrolyte layer having concaves and convexes in a main surface thereof is formed on at least one of surfaces of the anode chemical conversion foil and the facing cathode foil that face by winding the anode chemical conversion foil and the facing cathode foil, among surfaces of the anode chemical conversion foil and surfaces of the facing cathode foil. The anode chemical conversion foil and the facing cathode foil are wound with no separator interposed therebetween. After the anode chemical conversion foil and the facing cathode foil are wound, an interspace formed between the anode chemical conversion foil the facing cathode foil by the concaves and convexes is filled with an electrolyte solution, or filled with a second solid electrolyte layer containing a conductive polymer.

Preferably, in the method of manufacturing an electrolytic capacitor described above, the first solid electrolyte layer has a thickness of not less than 0.1 μm.

Preferably, in the method of manufacturing an electrolytic capacitor described above, a ratio of a depth of a concave to a thickness of a convex in the concaves and convexes is not less than 0.05 and not more than 0.9.

Preferably, in the method of manufacturing an electrolytic capacitor described above, the concaves and convexes are formed all over the main surface of the first solid electrolyte layer.

According to the present invention, an electrolytic capacitor including a capacitor element configured by winding an anode chemical conversion foil and a facing cathode foil with no separator interposed therebetween, in which an electrolyte having desired characteristics can be formed in an interspace formed between the anode chemical conversion foil and the facing cathode foil, and a manufacturing method thereof can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view schematically showing a capacitor element constituting an electrolytic capacitor in Embodiment 1.

FIG. 2 is a cross sectional view schematically showing the electrolytic capacitor in Embodiment 1.

FIG. 3 is an enlarged fragmentary view (a cross sectional view) of a portion surrounded by a line III in FIG. 2.

FIG. 4 is a cross sectional view schematically showing concaves and convexes formed in a surface of a first solid electrolyte layer in Embodiment 1.

FIG. 5 is an enlarged fragmentary view (a cross sectional view) related to FIG. 3 showing an electrolytic capacitor in another configuration of Embodiment 1.

FIG. 6 is an enlarged fragmentary view (a cross sectional view) related to FIG. 3 showing an electrolytic capacitor in still another configuration of Embodiment 1.

FIG. 7 is a view showing electrical characteristics of electrolytic capacitors in Examples 1 to 9 and Comparative Examples 1 and 2.

FIG. 8 is a view showing electrical characteristics of electrolytic capacitors in another example.

FIG. 9 is a view showing electrical characteristics of electrolytic capacitors in another example.

### DESCRIPTION OF THE PREFERRED EMBODIMENTS

Hereinafter, an electrolytic capacitor and a manufacturing method thereof in each embodiment in accordance with the present invention will be described with reference to the drawings. When the number, amount, or the like is referred to in the embodiments described below, the scope of the present invention is not necessarily limited to such a number, amount, or the like, unless otherwise specified. In the embodiments described below, identical or corresponding parts will be designated by the same reference numerals, and an overlapping description may not be repeated.

### Embodiment 1

### Electrolytic Capacitor

(Configuration)

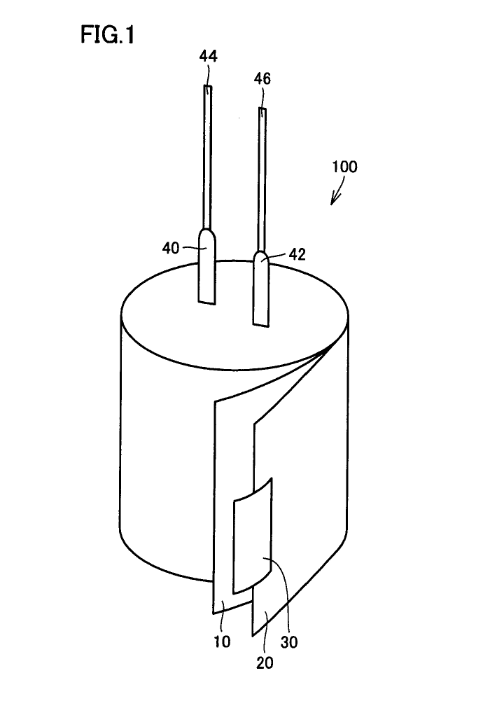

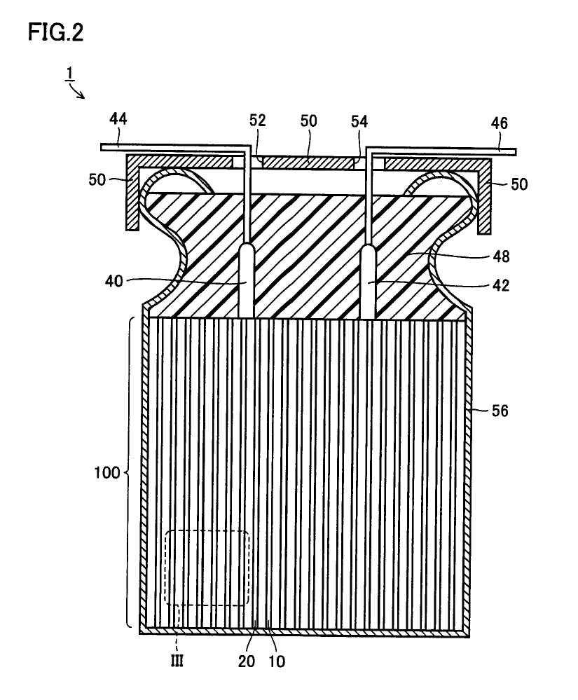

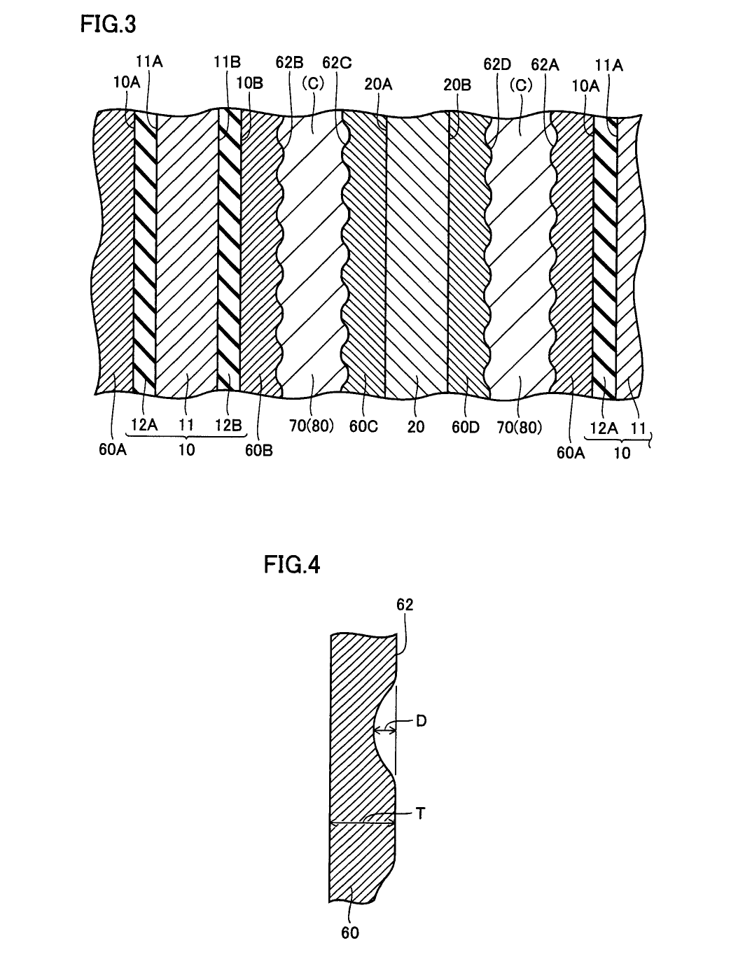

Referring to FIGS. 1 and 2, an entire configuration of an electrolytic capacitor in the present embodiment will be described. Referring to FIG. 3, a detailed configuration of an anode chemical conversion foil 10 and a facing cathode foil 20 in the present embodiment will be described.

Referring to FIG. 1, the electrolytic capacitor in the present embodiment includes a capacitor element 100. Capacitor element 100 has anode chemical conversion foil 10 and facing cathode foil 20. Anode chemical conversion foil 10 and facing cathode foil 20 are wound in a state overlapped each other, with no separator interposed therebetween. The winding is secured, for example, with a winding stop tape 30 provided at one end of facing cathode foil 20.

A lead tab terminal 40 for an anode is connected to anode chemical conversion foil 10, and an anode lead 44 is connected to lead tab terminal 40. A lead tab terminal 42 for a cathode is connected to facing cathode foil 20, and a cathode lead 46 is connected to lead tab terminal 42. Capacitor element 100 may include not less than three lead tab terminals and not less than three leads. Details of anode chemical conversion foil 10, facing cathode foil 20, and the like will be described later.

Referring to FIG. 2, capacitor element 100 configured as described above is housed in a case 56. Case 56 is made of, for example, aluminum. A sealing rubber 48 is provided on a side of capacitor element 100 closer to an opening of case 56 (i.e., an upper side in a paper plane of FIG. 2). Capacitor element 100 is sealed inside case 56 with sealing rubber 48.

A seat plate 50 is provided to cover the opening of case 56 for capacitor element 100. Seat plate 50 is provided with an opening 52 and an opening 54. On a surface of seat plate 50, anode lead 44 is exposed through opening 52, and cathode lead 46 is exposed through opening 54. Anode lead 44 and cathode lead 46 are bent to follow the surface of seat plate 50. An electrolytic capacitor 1 in the present embodiment is configured as described above.

(Anode Chemical Conversion Foil 10, Facing Cathode Foil 20, First Solid Electrolyte Layers 60A to 60D)

Referring to FIG. 3, details of anode chemical conversion foil 10, facing cathode foil 20, and first solid electrolyte layers 60A to 60D in the present embodiment will be described. Anode chemical conversion foil 10 and facing cathode foil 20 are wound in an overlapped state (with no separator interposed therebetween) to constitute capacitor element 100. In a cross sectional view of anode chemical conversion foil 10 and facing cathode foil 20 in a wound state, anode chemical conversion foil 10 and facing cathode foil 20 are alternately arranged in a radial direction of capacitor element 100 (i.e., a horizontal direction in a paper plane of FIG. 3), with a predetermined gap therebetween.

Anode chemical conversion foil 10 in the present embodiment includes a metal foil 11 and dielectric oxide films 12A, 12B. Metal foil 11 constituting anode chemical conversion foil 10 is, for example, an aluminum foil having a thickness of about 0.05 mm to about 0.11 mm. Dielectric oxide films 12A, 12B are formed by roughening surfaces 11A, 11B of metal foil 11 by etching or the like, and then performing chemical conversion treatment on roughened surfaces 11A, 11B.

Facing cathode foil 20 in the present embodiment is made of a metal foil. The metal foil constituting facing cathode foil 20 is, for example, an aluminum foil having a thickness of about 0.02 mm to about 0.05 mm. Facing cathode foil 20 may be configured substantially identically to anode chemical conversion foil 10.

The first solid electrolyte layers 60A to 60D are respectively formed on both of facing surfaces of anode chemical conversion foil 10 and facing cathode foil 20, among surfaces of anode chemical conversion foil 10 and surfaces of facing cathode foil 20. The first solid electrolyte layers 60A to 60D mechanically (physically) separate anode chemical conversion foil 10 from facing cathode foil 20, and hold an electrolyte (a second solid electrolyte layer 70 or an electrolyte solution 80) described later. For the separation and holding described above, the first solid electrolyte layers 60A to 60D may be formed on only at least one of facing surfaces of anode chemical conversion foil 10 and facing cathode foil 20, among surfaces of anode chemical conversion foil 10 and surfaces of facing cathode foil 20.

In the present embodiment, a surface 10B of anode chemical conversion foil 10 faces a surface 20A of facing cathode foil 20. The first solid electrolyte layer 60B is formed on surface 10B of anode chemical conversion foil 10. The first solid electrolyte layer 60C is formed on surface 20A of facing cathode foil 20. A surface 10A of anode chemical conversion foil 10 faces a surface 20B of facing cathode foil 20. The first solid electrolyte layer 60A is formed on surface 10A of anode chemical conversion foil 10. The first solid electrolyte layer 60D is formed on surface 20B of facing cathode foil 20.

The first solid electrolyte layers 60A to 60D are made of a conductive polymer. It is desirable that the first solid electrolyte layers 60A to 60D contain a conductive polymer of the aliphatic series, the aromatic series, or the heterocyclic series, as a single component, a mixture, or a composite. The conductive polymer of the aliphatic series, the aromatic series, or the heterocyclic series is, for example, a polypyrrole, polythiophene, polyfuran, or polyaniline conductive polymer.

Concaves and convexes are formed in surfaces (“main surfaces” in the present invention) of the first solid electrolyte layers 60A to 60D. Specifically, the concaves and convexes are formed in each of a surface 62A of the first solid electrolyte layer 60A, a surface 62B of the first solid electrolyte layer 60B, a surface 62C of the first solid electrolyte layer 60C, and a surface 62D of the first solid electrolyte layer 60D.

The shape of the concaves and convexes formed in the surfaces (“main surfaces” in the present invention) of the first solid electrolyte layers 60A to 60D includes, for example, a shape obtained by roughening the surfaces, a shape in which minute projections are provided on the surfaces in a lattice pattern, or a shape in which numerous minute projections are irregularly provided on the surfaces. It is desirable that the concaves and convexes are formed all over the surfaces (main surfaces) of the first solid electrolyte layers 60A to 60D. To form the concaves and convexes all over the surfaces means to form them all over a surface necessary to form an interspace C described later, and does not mean that, if there is any surface having no interspace C formed thereon, such a case is considered as not falling within the technical scope of the present invention.

In FIG. 3, for convenience of illustration, the concaves and convexes formed in surface 62A of the first solid electrolyte layer 60A are all separated from the concaves and convexes formed in surface 62D of the first solid electrolyte layer 60D. In fact, some convexes formed in surface 62A of the first solid electrolyte layer 60A are in contact with some convexes formed in surface 62D of the first solid electrolyte layer 60D.

In FIG. 3, for convenience of illustration, the concaves and convexes formed in surface 62B of the first solid electrolyte layer 60B are all separated from the concaves and convexes formed in surface 62C of the first solid electrolyte layer 60C. In fact, some convexes formed in surface 62B of the first solid electrolyte layer 60B are in contact with some convexes formed in surface 62C of the first solid electrolyte layer 60C.

By the concaves and convexes formed in surfaces 62A to 62D of the first solid electrolyte layers 60A to 60D, interspace C is formed between anode chemical conversion foil 10 and facing cathode foil 20.

The second solid electrolyte layer 70 as an electrolyte is formed in interspace C. The second solid electrolyte layer 70 is made of a conductive polymer, as with the first solid electrolyte layers 60A to 60D. It is desirable that the second solid electrolyte layer 70 contains a conductive polymer of the aliphatic series, the aromatic series, or the heterocyclic series, as a single component, a mixture, or a composite. The conductive polymer of the aliphatic series, the aromatic series, or the heterocyclic series is, for example, a polypyrrole, polythiophene, polyfuran, or polyaniline conductive polymer.

Interspace C may be filled with electrolyte solution 80. Electrolyte solution 80 contains, for example, γ-butyrolactone and an organic amine salt. Electrolytic capacitor 1 in the present embodiment is configured as described above.

(Effects)

According to the electrolytic capacitor in the present embodiment, by the concaves and convexes formed in each of surface 62B of the first solid electrolyte layer 60B and surface 62C of the first solid electrolyte layer 60C, interspace C is formed therebetween. Interspace C suppresses surface 62B and surface 62C from adhering tightly to each other even in the state where anode chemical conversion foil 10 and facing cathode foil 20 are wound. By the concaves and convexes formed in each of surface 62A of the first solid electrolyte layer 60A and surface 62D of the first solid electrolyte layer 60D, interspace C is also formed therebetween. Interspace C suppresses surface 62A and surface 62D from adhering tightly to each other even in the state where anode chemical conversion foil 10 and facing cathode foil 20 are wound.

Since surface 62B and surface 62C do not adhere tightly to each other, and surface 62A and surface 62D do not adhere tightly to each other, the second solid electrolyte layer 70 (or electrolyte solution 80) is formed utilizing interspace C, with a predetermined solution fully penetrating (or filling) interspace C. The electrolytic capacitor in the present embodiment includes capacitor element 100 configured by winding anode chemical conversion foil 10 and facing cathode foil 20 with no separator interposed therebetween, and an electrolyte capable of fully exhibiting desired characteristics is formed in interspace C formed between anode chemical conversion foil 10 and facing cathode foil 20. Details of the desired characteristics will be described later as examples.

Since the electrolytic capacitor in the present embodiment has no separator, an increase in the volume of the electrolytic capacitor is also suppressed. In a case where the electrolytic capacitor in the present embodiment is fabricated to have the same volume as that of a conventional electrolytic capacitor having a separator, the electrolytic capacitor in the present embodiment can obtain a capacity higher than that of the conventional electrolytic capacitor. In a case where the electrolytic capacitor in the present embodiment is fabricated to have the same capacity as that of a conventional electrolytic capacitor having a separator, the electrolytic capacitor in the present embodiment can be fabricated with a volume smaller than that of the conventional electrolytic capacitor.

(Another Configuration of Embodiment 1)

Another configuration of Embodiment 1 described above (in particular, anode chemical conversion foil 10 and facing cathode foil 20) will be described. FIG. 4 is a cross sectional view schematically showing a first solid electrolyte layer 60 and concaves and convexes formed in a surface 62 of the first solid electrolyte layer 60. The first solid electrolyte layer 60 in FIG. 4 is equivalent to the first solid electrolyte layers 60A to 60D in Embodiment 1 described above. Surface 62 in FIG. 4 is equivalent to surfaces 62A to 62D in Embodiment 1 described above.

Referring to FIG. 4, it is desirable that, in the concaves and convexes formed in surface 62 of the first solid electrolyte layer 60, a ratio of a depth of a concave to a thickness of a convex is not less than about 0.05 and not more than about 0.9. Specifically, it is desirable that, with respect to a thickness T of the first solid electrolyte layer 60, a depth D of a concave satisfies an expression of about 5%≦(D/T×100) about 90%. Hereinafter, a value of D/T×100 will be referred to as a ratio (D/T value).

If the ratio (D/T value) is less than about 5%, an equivalent series resistance ESR is rapidly increased. On the other hand, if the ratio (D/T value) is more than about 90%, the concaves and convexes formed in the surfaces of the first solid electrolyte layers (60A to 60D) become larger, causing film breakdown mainly at convexes. Therefore, it is desirable that, in the concaves and convexes formed in surface 62 of the first solid electrolyte layer 60, the ratio of the depth of a concave to the thickness of a convex is not less than about 0.05 and not more than about 0.9.

More preferably, in the concaves and convexes formed in surface 62 of the first solid electrolyte layer 60, the ratio of the depth of a concave to the thickness of a convex is not less than about 0.3 and not more than about 0.7.

It is desirable that thickness T of the first solid electrolyte layer 60 is not less than about 0.1 μm. If thickness T of the first solid electrolyte layer 60 is less than about 0.1 μm, sufficient interspace C may not be formed even when depth D of a concave with respect to thickness T of the first solid electrolyte layer 60 satisfies the expression of about 5% the ratio (D/T value) about 90%. Therefore, it is desirable that thickness T of the first solid electrolyte layer 60 is not less than about 0.1 μm.

It is desirable that thickness T of the first solid electrolyte layer 60 is not more than about 100 μm, for the reason described below. If thickness T of the first solid electrolyte layer 60 is more than about 100 μm, the second solid electrolyte layer 70 or electrolyte solution 80 can be fully provided in interspace C. However, electrical characteristics as an electrolytic capacitor are deteriorated.

In the present invention, the anode chemical conversion foil and the facing cathode foil are wound with no separator interposed therebetween. If a total film thickness as the sum of the thickness of the first solid electrolyte layer and the thickness of the electrolyte is greater than a thickness of an ordinary separator, the number in which the anode chemical conversion foil and the facing cathode foil are wound is reduced, when compared with that of an electrolytic capacitor provided with the ordinary separator.

If the number in which the anode chemical conversion foil and the facing cathode foil are wound is reduced, a capacitance (Cap) is reduced. Therefore, since an ordinary separator has a film thickness of about 200 μm, it is desirable that thickness T of the first solid electrolyte layer 60 is not more than about 100 μm, which is half the film thickness.

More preferably, it is desirable that thickness T of the first solid electrolyte layer 60 is not less than about 5 μm and less than about 20 μm, because a separator with a film thickness of about 40 μm is used in an ordinary low equivalent series resistance (ESR) electrolytic capacitor.

Further, although Embodiment 1 describes a case where the first solid electrolyte layers (60A to 60D) are formed on both of the facing surfaces of anode chemical conversion foil 10 and facing cathode foil 20, among the surfaces of anode chemical conversion foil 10 and the surfaces of facing cathode foil 20, with reference FIG. 3, the present invention is not limited to the case.

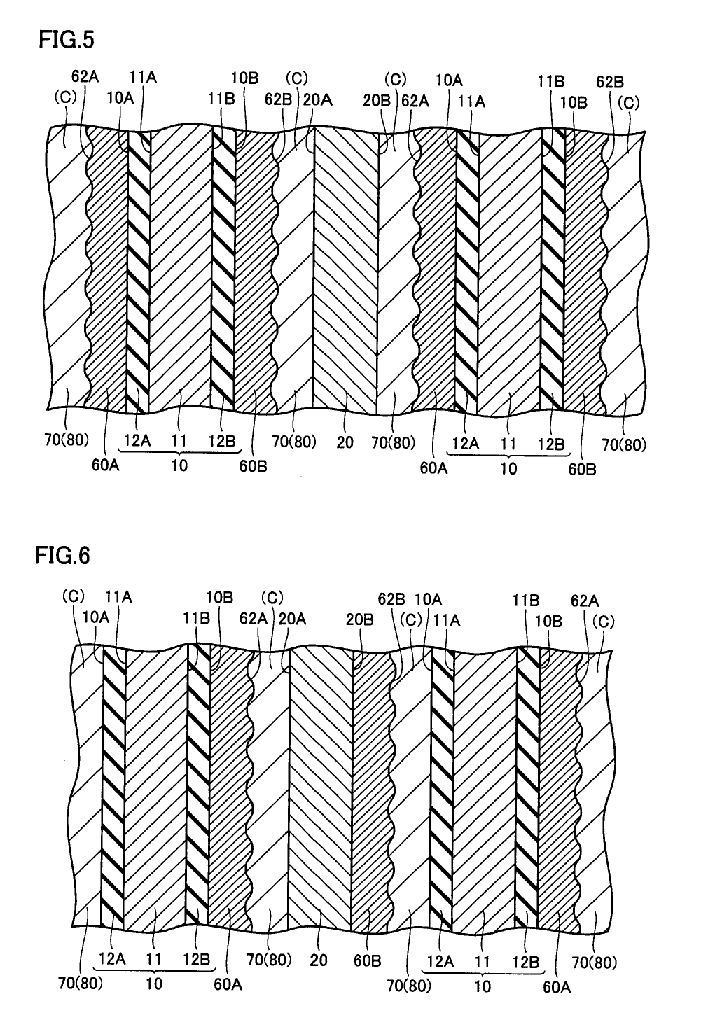

Referring to FIG. 5 or 6, the first solid electrolyte layer may be formed on one of the facing surfaces of anode chemical conversion foil 10 and facing cathode foil 20, among the surfaces of anode chemical conversion foil 10 and the surfaces of facing cathode foil 20.

In FIG. 5, the first solid electrolyte layer 60B is formed on only surface 10B of anode chemical conversion foil 10, of facing surface 10B of anode chemical conversion foil 10 and surface 20A of facing cathode foil 20. The first solid electrolyte layer 60A is formed on only surface 10A of anode chemical conversion foil 10, of facing surface 10A of anode chemical conversion foil 10 and surface 20B of facing cathode foil 20.

In FIG. 6, the first solid electrolyte layer 60A is formed on only surface 10B of anode chemical conversion foil 10, of facing surface 10B of anode chemical conversion foil 10 and surface 20A of facing cathode foil 20. The first solid electrolyte layer 60B is formed on only surface 20B of facing cathode foil 20, of facing surface 10A of anode chemical conversion foil 10 and surface 20B of facing cathode foil 20.

As in Embodiment 1 described above, in FIGS. 5 and 6, concaves and convexes are formed in surfaces (“main surfaces” in the present invention) of the first solid electrolyte layers 60A, 60B. The concaves and convexes are formed in surface 62A of the first solid electrolyte layer 60A and surface 62B of the first solid electrolyte layer 60B. By the concaves and convexes formed in surface 62A of the first solid electrolyte layers 60A and the concaves and convexes formed in surface 62B of the first solid electrolyte layers 60B, interspace C is formed between anode chemical conversion foil 10 and facing cathode foil 20.

As shown in FIG. 5, formation of interspace C suppresses facing surfaces 62A, 20B and facing surfaces 62B, 20A from adhering tightly. As shown in FIG. 6, formation of interspace C suppresses facing surfaces 62A, 20A and facing surfaces 62B, 10A from adhering tightly. The second solid electrolyte layer 70 is formed in interspace C (FIGS. 5 and 6). Interspace C may be filled with electrolyte solution 80. Also with the configuration described above, the electrolytic capacitor can obtain effects similar to those described in Embodiment 1.

### Embodiment 2

### Method of Manufacturing Electrolytic Capacitor

Referring to FIG. 3, a method of manufacturing an electrolytic capacitor in the present embodiment will be described. Electrolytic capacitor 1 in the present embodiment is manufactured as described below.

(Anode Chemical Conversion Foil 10, Facing Cathode Foil 20)

Firstly, anode chemical conversion foil 10 is prepared. To obtain anode chemical conversion foil 10, a metal such as aluminum is cut as metal foil 11 having predetermined dimensions. Surfaces 11A, 11B of metal foil 11 are roughened by etching or the like, and chemical conversion treatment is performed on roughened surfaces 11A, 11B. By the chemical conversion treatment, dielectric oxide films 12A, 12B are formed on surfaces 11A, 11B.

It is desirable that the chemical conversion treatment is performed before the metal such as aluminum is cut as metal foil 11. Surfaces of the metal such as aluminum before being cut are roughened by etching or the like, and chemical conversion treatment is performed on the roughened surfaces. The metal such as aluminum having dielectric oxide films formed on the surfaces thereof by the chemical conversion treatment is cut as metal foil 11. Anode chemical conversion foil 10 can be prepared as described above.

Next, facing cathode foil 20 is prepared. Facing cathode foil 20 is prepared with no chemical conversion treatment performed on surfaces 20A, 20B of a metal foil (20). Facing cathode foil 20 may be prepared substantially identically to anode chemical conversion foil 10. Facing cathode foil 20 can be prepared as described above.

(First Solid Electrolyte Layers 60A to 60D)

After anode chemical conversion foil 10 and facing cathode foil 20 are prepared, the first solid electrolyte layers 60A to 60D are formed on at least one of surfaces of anode chemical conversion foil 10 and facing cathode foil 20 that face by winding anode chemical conversion foil 10 and facing cathode foil 20, among the surfaces of anode chemical conversion foil 10 and the surfaces of facing cathode foil 20. In the present embodiment, the first solid electrolyte layers 60A to 60D are respectively formed on both of the facing surfaces of anode chemical conversion foil 10 and facing cathode foil 20, among the surfaces of anode chemical conversion foil 10 and the surfaces of facing cathode foil 20. When anode chemical conversion foil 10 or facing cathode foil 20 is prepared, the first solid electrolyte layers 60A to 60D may be formed on the surface(s) of anode chemical conversion foil 10 or facing cathode foil 20 constituting one (or both) of the surfaces described above, before the foil is cut as a metal foil.

The first solid electrolyte layers 60A to 60D to be formed on the surfaces of anode chemical conversion foil 10 or the surfaces of facing cathode foil 20 can be formed as conductive polymer layers by impregnating anode chemical conversion foil 10 or facing cathode foil 20 with a dispersion element solution containing dispersion elements (fine particles) of a conductive polymer such as polypyrrole, polythiophene, or the like, and thereafter drying the solution. The first solid electrolyte layers 60A to 60D can also be formed as conductive polymer layers by applying a dispersion element solution to anode chemical conversion foil 10 or facing cathode foil 20, and thereafter drying the solution.

The first solid electrolyte layers 60A to 60D to be formed on the surfaces of anode chemical conversion foil 10 or the surfaces of facing cathode foil 20 may be formed as conductive polymer layers by impregnating anode chemical conversion foil 10 or facing cathode foil 20 with a dispersion solution (soluble element solution) prepared by dissolving polyaniline in a solvent, and thereafter drying the solution. The first solid electrolyte layers 60A to 60D may also be formed as conductive polymer layers by applying a dispersion solution (soluble element solution) to anode chemical conversion foil 10 or facing cathode foil 20, and thereafter drying the solution.

The first solid electrolyte layers 60A to 60D to be formed on the surfaces of anode chemical conversion foil 10 or the surfaces of facing cathode foil 20 may be formed as conductive polymer layers by electropolymerizing the surfaces of anode chemical conversion foil 10 or the surfaces of facing cathode foil 20. For example, a conductive polymer layer can be formed by applying a voltage with anode chemical conversion foil 10 or facing cathode foil 20 immersed in a polymerization solution containing pyrrole or thiophene as a monomer and a dopant that provides conductivity to a conductive polymer.

The first solid electrolyte layers 60A to 60D to be formed on the surfaces of anode chemical conversion foil 10 or the surfaces of facing cathode foil 20 may be formed as conductive polymer layers by chemically polymerizing the surfaces of anode chemical conversion foil 10 or the surfaces of facing cathode foil 20. For example, a conductive polymer layer can be formed by immersing anode chemical conversion foil 10 or facing cathode foil 20 in a polymerization solution containing pyrrole or thiophene as a monomer and an oxidant (also serving as a dopant), and thereafter raising and heating the foil to complete a polymerization reaction.

As described in Embodiment 1 (FIG. 3) and another configuration of Embodiment 1 (FIGS. 5, 6), the first solid electrolyte layers 60A to 60D may be formed on both of the facing surfaces of anode chemical conversion foil 10 and facing cathode foil 20, or may be formed on one of the facing surfaces of anode chemical conversion foil 10 and facing cathode foil 20, among the surfaces of anode chemical conversion foil 10 and the surfaces of facing cathode foil 20.

(Concaves and Convexes Formed in Surfaces of First Solid Electrolyte Layers 60A to 60D)

After the first solid electrolyte layers 60A to 60D are formed on the surfaces of anode chemical conversion foil 10 or the surfaces of facing cathode foil 20, concaves and convexes are formed in the surfaces (main surfaces) of the first solid electrolyte layers 60A to 60D. The concaves and convexes may be formed all over the surfaces (main surfaces) of the first solid electrolyte layers 60A to 60D. To form the concaves and convexes all over the surfaces means to form them all over a surface necessary to form interspace C described later, and does not mean that, if there is any surface having no interspace C formed thereon, such a case is considered as not falling within the technical scope of the present invention.

The concaves and convexes to be formed in the surfaces of the first solid electrolyte layers 60A to 60D can be formed by the doctor blade method, using a dispersion element solution of a conductive polymer or a soluble element solution of a conductive polymer.

The concaves and convexes to be formed in the surfaces of the first solid electrolyte layers 60A to 60D may be formed by applying (spraying) a dispersion element solution of a conductive polymer or a soluble element solution of a conductive polymer to the surfaces of the first solid electrolyte layers 60A to 60D by the ink jet method.

As described in another configuration of Embodiment 1 (FIG. 4), it is desirable that, in the concaves and convexes formed in surface 62 of the first solid electrolyte layer 60, a ratio of a depth of a concave to a thickness of a convex is not less than about 0.05 and not more than about 0.9. More preferably, in the concaves and convexes formed in surface 62 of the first solid electrolyte layer 60, the ratio of the depth of a concave to the thickness of a convex is not less than about 0.3 and not more than about 0.7.

(Winding, Formation of Electrolyte)

Referring to FIG. 1 again, after the concaves and convexes are formed in the surfaces (main surfaces) of the first solid electrolyte layers 60A to 60D, anode chemical conversion foil 10 and facing cathode foil 20 are wound in an overlapped state, with no separator interposed therebetween. After anode chemical conversion foil 10 and facing cathode foil 20 are wound, the winding of anode chemical conversion foil 10 and facing cathode foil 20 is secured, for example, with winding stop tape 30 provided at one end of facing cathode foil 20.

When anode chemical conversion foil 10 and facing cathode foil 20 are wound, lead tab terminal 40 for the anode is connected to anode chemical conversion foil 10, and anode lead 44 is connected to lead tab terminal 40. Lead tab terminal 42 for the cathode is connected to facing cathode foil 20, and cathode lead 46 is connected to lead tab terminal 42. Thereby, capacitor element 100 can be obtained.

Chemical conversion treatment of a cut section and heat treatment are performed on capacitor element 100. An electrolyte is formed inside capacitor element 100 (in interspace C formed between the anode chemical conversion foil and the facing cathode foil by the concaves and convexes described above).

The electrolyte formed in interspace C is formed as a conductive polymer layer (the second solid electrolyte layer 70) by chemical polymerization. For example, capacitor element 100 is impregnated with a polymerization solution containing pyrrole or thiophene as a monomer and an oxidant (also serving as a dopant), and thereafter is raised and heated to complete a polymerization reaction. A conductive polymer layer is formed as a result of completion of the polymerization reaction.

The electrolyte formed in interspace C may be formed as a conductive polymer layer (the second solid electrolyte layer 70) by filling interspace C with a dispersion element solution containing dispersion elements (fine particles) of polythiophene or polypyrrole, and thereafter drying the solution.

The electrolyte formed in interspace C may be formed as a conductive polymer layer (the second solid electrolyte layer 70) by filling interspace C with a dispersion solution (soluble element solution) prepared by dissolving polyaniline in a solvent, and thereafter drying the solution.

The electrolyte formed in interspace C may be formed as a conductive polymer layer (the second solid electrolyte layer 70) by applying a voltage, with interspace C filled with a polymerization solution containing pyrrole or thiophene as a monomer and a dopant that provides conductivity to a conductive polymer, to electropolymerize the polymerization solution.

The electrolyte formed in interspace C may be formed by filling interspace C with electrolyte solution 80 containing γ-butyrolactone and an organic amine salt.

Capacitor element 100 having the second solid electrolyte layer 70 formed in interspace C or having interspace C filled with electrolyte solution 80 is housed in case 56 (FIG. 2). After capacitor element 100 is housed in case 56, sealing rubber 48 is inserted on an opening side of case 56 to cover capacitor element 100.

After sealing rubber 48 is inserted, pressing in a lateral direction and curling are performed on the opening of case 56. Sealing rubber 48 is secured. Then, aging treatment is performed, and plastic seat plate 50 is inserted onto a curled surface formed in case 56. To form electrode terminals, pressing and bending are performed on leads 44, 46. Electrolytic capacitor 1 is manufactured as described above.

(Effects)

According to the method of manufacturing an electrolytic capacitor in the present embodiment, interspace C is formed by the concaves and convexes formed in each of surfaces 62A to 62D, as described in Embodiment 1 in connection with the effects thereof. Interspace C suppresses facing surfaces 62B and 62C from adhering tightly, and suppresses facing surfaces 62A and 62D from adhering tightly.

The second solid electrolyte layer 70 or electrolyte solution 80 provided in interspace C is provided utilizing interspace C, with a predetermined solution fully penetrating (or filling) interspace C. According to the method of manufacturing an electrolytic capacitor in the present embodiment, it is possible to obtain an electrolytic capacitor including capacitor element 100 configured by winding anode chemical conversion foil 10 and facing cathode foil 20 with no separator interposed therebetween, and having an electrolyte capable of fully exhibiting desired characteristics in interspace C formed between anode chemical conversion foil 10 and facing cathode foil 20. Details of the desired characteristics will be described later as examples.

Hereinafter, the present invention will be described in more detail, giving examples. However, the present invention is not limited thereto.

### EXAMPLES, COMPARATIVE EXAMPLES

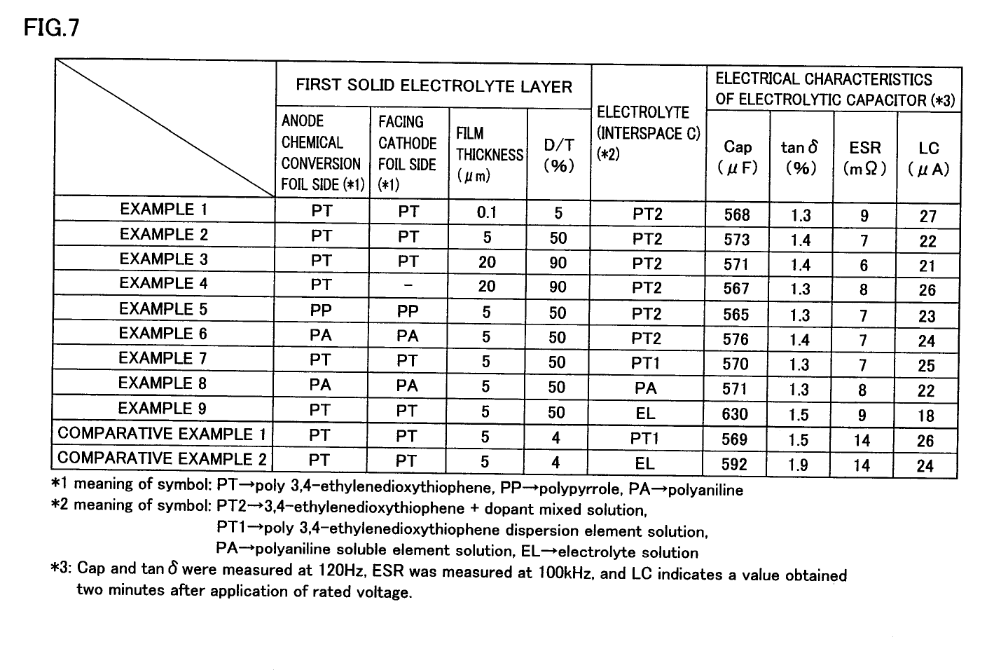

Hereinafter, referring to FIG. 7, Examples 1 to 9 in accordance with the present invention and Comparative Examples 1 and 2 in connection with the present invention will be described in detail. In electrolytic capacitors in accordance with Examples 1 to 9 and Comparative Examples 1 and 2, an anode chemical conversion foil and a facing cathode foil are wound with no separator interposed therebetween. Electrical characteristics of the electrolytic capacitors in accordance with Examples 1 to 9 and Comparative Examples 1 and 2 indicate an average value of 30 electrolytic capacitors produced based on configurations each described below. Each electrolytic capacitor has a size of about 8 mm in φ and about 12.0 mm in height.

In FIG. 7, a capacitance Cap (μF) and a tangent of loss angle tan δ (%) indicated as electrical characteristics of an electrolytic capacitor were measured at a frequency of about 120 Hz. Equivalent series resistance ESR (mΩ) was measured at a frequency of about 100 kHz. A leak current LC (μA) indicates a value obtained about two minutes after application of a rated voltage of 4.0 V.

### Example 1

An electrolytic capacitor in the present example was configured as described below. Conductive polymer layers as the first solid electrolyte layers 60A, 60B were formed on surfaces 10A, 10B of anode chemical conversion foil 10 (FIG. 3) by impregnating surfaces 10A, 10B with a dispersion element solution containing dispersion elements of poly 3,4-ethylenedioxythiophene (or applying the solution to surfaces 10A, 10B). Conductive polymer layers as the first solid electrolyte layers 60C, 60D were formed on surfaces 20A, 20B of facing cathode foil 20 by impregnating surfaces 20A, 20B with a dispersion element solution containing dispersion elements of poly 3,4-ethylenedioxythiophene or applying the solution to surfaces 20A, 20B, as in anode chemical conversion foil 10. Film thicknesses of the first solid electrolyte layers 60A to 60D were each set to about 0.1 μm. The ratio (D/T value) of depth D of a concave to thickness T of the first solid electrolyte layers 60A to 60D was set to about 5%.

An electrolyte formed in interspace C was formed as a conductive polymer layer (the second solid electrolyte layer 70) by impregnating a capacitor element with 3,4-ethylenedioxythiophene as a monomer and a ferric p-toluenesulfonic acid alcohol solution as an oxidant (also serving as a dopant), as a polymerization solution, and performing chemical polymerization.

### Example 2

An electrolytic capacitor in the present example was configured as described below. The types of the first solid electrolyte layers 60A to 60D respectively formed on the surfaces of anode chemical conversion foil 10 and facing cathode foil 20 were the same as those in Example 1. The film thicknesses of the first solid electrolyte layers 60A to 60D were each set to about 5 μm. The ratio (D/T value) of depth D of a concave to thickness T of the first solid electrolyte layers 60A to 60D was set to about 50%. An electrolyte was formed in interspace C as in Example 1.

### Example 3

An electrolytic capacitor in the present example was configured as described below. The types of the first solid electrolyte layers 60A to 60D respectively formed on the surfaces of anode chemical conversion foil 10 and facing cathode foil 20 were the same as those in Example 1. The film thicknesses of the first solid electrolyte layers 60A to 60D were each set to about 20 μm. The ratio (D/T value) of depth D of a concave to thickness T of the first solid electrolyte layers 60A to 60D was set to about 90%. An electrolyte was formed in interspace C as in Example 1.

### Example 4

An electrolytic capacitor in the present example was configured as described below. Conductive polymer layers as the first solid electrolyte layers 60A, 60B were formed on surfaces 10A, 10B of anode chemical conversion foil 10 (FIG. 3) by impregnating surfaces 10A, 10B with a dispersion element solution containing dispersion elements of poly 3,4-ethylenedioxythiophene or applying the solution to surfaces 10A, 10B. The film thicknesses of the first solid electrolyte layers 60A to 60B were each set to about 5 μm. The ratio (D/T value) of depth D of a concave to thickness T of the first solid electrolyte layers 60A to 60B was set to about 90%. The first solid electrolyte layer was not formed on surfaces 20A, 20B of facing cathode foil 20. An electrolyte was formed in interspace C as in Example 1.

### Example 5

An electrolytic capacitor in the present example was configured as described below. Conductive polymer layers as the first solid electrolyte layers 60A, 60B were formed on surfaces 10A, 10B of anode chemical conversion foil 10 (FIG. 3) by impregnating surfaces 10A, 10B with a dispersion element solution containing dispersion elements of polypyrrole. Conductive polymer layers as the first solid electrolyte layers 60C, 60D were formed on surfaces 20A, 20B of facing cathode foil 20 by electropolymerizing polypyrrole, as in anode chemical conversion foil 10. The film thicknesses of the first solid electrolyte layers 60A to 60D were each set to about 5 μm. The ratio (D/T value) of depth D of a concave to thickness T of the first solid electrolyte layers 60A to 60D was set to about 50%. An electrolyte was formed in interspace C as in Example 1.

### Example 6

An electrolytic capacitor in the present example was configured as described below. Conductive polymer layers as the first solid electrolyte layers 60A, 60B were formed on surfaces 10A, 10B of anode chemical conversion foil 10 (FIG. 3) by impregnating surfaces 10A, 10B with a solution containing polyaniline (or applying the solution to surfaces 10A, 10B). Conductive polymer layers as the first solid electrolyte layers 60C, 60D were formed on surfaces 20A, 20B of facing cathode foil 20 by impregnating surfaces 20A, 20B with polyaniline (or applying polyaniline to surfaces 20A, 20B), as in anode chemical conversion foil 10. The film thicknesses of the first solid electrolyte layers 60A to 60D were each set to about 5 μm. The ratio (D/T value) of depth D of a concave to thickness T of the first solid electrolyte layers 60A to 60D was set to about 50%. An electrolyte was formed in interspace C as in Example 1.

### Example 7

An electrolytic capacitor in the present example was configured as described below. The types, the film thicknesses, and the ratio (D/T value) of the first solid electrolyte layers 60A to 60D respectively formed on the surfaces of anode chemical conversion foil 10 and the surfaces of facing cathode foil 20 were the same as those in Example 2. An electrolyte formed in interspace C was formed as a conductive polymer layer (the second solid electrolyte layer 70) by filling interspace C with a dispersion element solution of poly 3,4-ethylenedioxythiophene.

### Example 8

An electrolytic capacitor in the present example was configured as described below. The types, the film thicknesses, and the ratio (D/T value) of the first solid electrolyte layers 60A to 60D respectively formed on the surfaces of anode chemical conversion foil 10 and the surfaces of facing cathode foil 20 were the same as those in Example 6. An electrolyte formed in interspace C was formed as a conductive polymer layer (the second solid electrolyte layer 70) by filling interspace C with a soluble element solution of polyaniline or applying the solution to interspace C.

### Example 9

An electrolytic capacitor in the present example was configured as described below. The types, the film thicknesses, and the ratio (D/T value) of the first solid electrolyte layers 60A to 60D respectively formed on the surfaces of anode chemical conversion foil 10 and the surfaces of facing cathode foil 20 were the same as those in Example 2. An electrolyte formed in interspace C was formed by filling interspace C with electrolyte solution 80 of γ-butyrolactone.

### Comparative Example 1

An electrolytic capacitor in the present comparative example was configured as described below. The types and the film thicknesses of the first solid electrolyte layers 60A to 60D respectively formed on the surfaces of anode chemical conversion foil 10 and the surfaces of facing cathode foil 20 were the same as those in Example 2. The ratio (D/T value) of depth D of a concave to thickness T of the first solid electrolyte layers 60A to 60D was set to about 4%. An electrolyte formed in interspace C was formed as a conductive polymer layer (the second solid electrolyte layer 70) by filling interspace C with a dispersion element solution of poly 3,4-ethylenedioxythiophene.

### Comparative Example 2

An electrolytic capacitor in the present comparative example was configured as described below. The types, the film thicknesses, and the ratio (D/T value) of the first solid electrolyte layers 60A to 60D respectively formed on the surfaces of anode chemical conversion foil 10 and the surfaces of facing cathode foil 20 were the same as those in Comparative Example 1. An electrolyte formed in interspace C was formed by filling interspace C with electrolyte solution 80.

It has been found from the examples and comparative examples (FIG. 7) described above, if the ratio (D/T value) is less than about 5%, equivalent series resistance ESR is rapidly increased, as is clear from the comparison between Example 1 and Comparative Examples 1 and 2. On the other hand, if the ratio (D/T value) is more than about 90%, the concaves and convexes formed in the surfaces of the first solid electrolyte layers (60A to 60D) become larger, causing film breakdown mainly at convexes. As shown in Examples 1 to 9, it is found to be desirable that, in the concaves and convexes formed in surface 62 of the first solid electrolyte layer 60, the ratio of the depth of a concave to the thickness of a convex is not less than about 0.05 and not more than about 0.9. As shown in Examples 1 to 9, it is found to be desirable that thickness T of the first solid electrolyte layer 60 is not less than about 0.1 μm.

### Another Example

Hereinafter, referring to FIGS. 4, 8, and 9, another example in accordance with the present invention will be described. Referring to FIG. 4, in another example, transition of characteristics of equivalent series resistance ESR obtained from the relationship between thickness T of the first solid electrolyte layer 60 and depth D of a concave in the concaves and convexes formed in surface 62 of the first solid electrolyte layer 60 (D/T value) will be described.

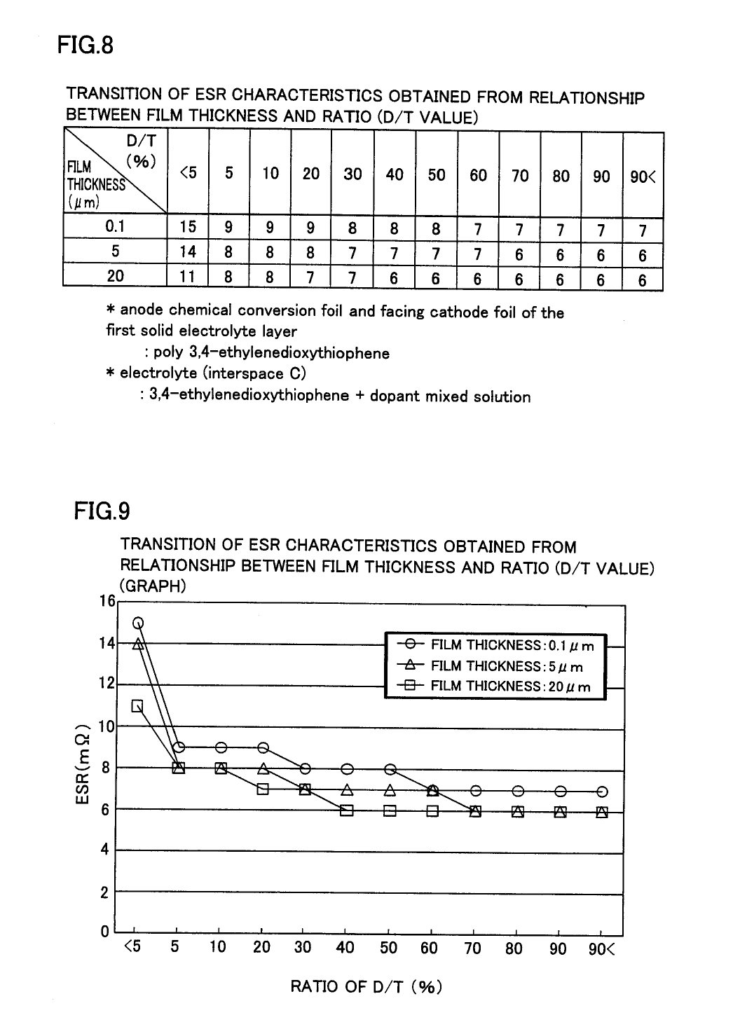

Specifically, referring to FIG. 8, electrolytic capacitors were fabricated, with thickness T of the first solid electrolyte layer 60 set to 0.1 μm, 5 μm, and 20 μm, and the D/T value with respect to each thickness T set to less than 5%, 5%, 10% to 90%, and more than 90%.

Further, in the electrolytic capacitor, conductive polymer layers as the first solid electrolyte layers 60A, 60B were formed on surfaces 10A, 10B of anode chemical conversion foil 10 (FIG. 3) by impregnating surfaces 10A, 10B with a dispersion element solution containing dispersion elements of poly 3,4-ethylenedioxythiophene (or applying the solution to surfaces 10A, 10B). Conductive polymer layers as the first solid electrolyte layers 60C, 60D were formed on surfaces 20A, 20B of facing cathode foil 20 by impregnating surfaces 20A, 20B with a dispersion element solution containing dispersion elements of poly 3,4-ethylenedioxythiophene (or applying the solution to surfaces 20A, 20B), as in anode chemical conversion foil 10. In addition, an electrolyte formed in interspace C was formed as a conductive polymer layer (the second solid electrolyte layer 70) by impregnating a capacitor element with 3,4-ethylenedioxythiophene as a monomer and a ferric p-toluenesulfonic acid alcohol solution as an oxidant (also serving as a dopant), as a polymerization solution, and performing chemical polymerization.

Equivalent series resistance ESR of the electrolytic capacitor in each case described above was measured. FIG. 9 shows data in FIG. 8 in a graph form. Referring to FIGS. 8 and 9, it can be seen that, in any of the cases where thickness T of the first solid electrolyte layer 60 is 0.1 μm, 5 μm, and 20 μm, equivalent series resistance ESR is rapidly increased when the ratio of D/T is less than 5%.

In any of the cases where thickness T of the first solid electrolyte layer 60 is 0.1 μm, 5 μm, and 20 μm, little change can be seen in equivalent series resistance ESR when the ratio of D/T is not less than 5% and less than 20%, and not less than 80% and less than 90%. On the other hand, it can be seen that equivalent series resistance ESR tends to be decreased when the ratio of D/T is not less than 30% and not more than about 70%. It is found to be desirable that, in the concaves and convexes formed in surface 62 of the first solid electrolyte layer 60, the ratio of the depth of a concave to the thickness of a convex is not less than about 30% and not more than about 70%.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An electrolytic capacitor comprising a capacitor element configured by winding an anode chemical conversion foil and a facing cathode foil with no separator interposed therebetween, wherein
a first solid electrolyte layer is formed on at least one of facing surfaces of said anode chemical conversion foil and said facing cathode foil, among surfaces of said anode chemical conversion foil and surfaces of said facing cathode foil,
concaves and convexes are formed in a main surface of said first solid electrolyte layer, and
an interspace formed between said anode chemical conversion foil and said facing cathode foil by said concaves and convexes is filled with an electrolyte solution or a second solid electrolyte layer containing a conductive polymer.

2. The electrolytic capacitor according to claim 1, wherein said first solid electrolyte layer has a thickness of not less than 0.1 μm.

3. The electrolytic capacitor according to claim 1, wherein a ratio of a depth of a concave to a thickness of a convex in said concaves and convexes is not less than 0.05 and not more than 0.9.

4. The electrolytic capacitor according to claim 1, wherein said concaves and convexes are formed all over said main surface of said first solid electrolyte layer.

5. A method of manufacturing an electrolytic capacitor, comprising the steps of:
preparing an anode chemical conversion foil and a facing cathode foil;
forming a first solid electrolyte layer having concaves and convexes in a main surface thereof, on at least one of surfaces of said anode chemical conversion foil and said facing cathode foil that face by winding said anode chemical conversion foil and said facing cathode foil, among surfaces of said anode chemical conversion foil and surfaces of said facing cathode foil;
winding said anode chemical conversion foil and said facing cathode foil with no separator interposed therebetween; and
forming an electrolyte solution or a second solid electrolyte layer containing a conductive polymer in an interspace formed between said anode chemical conversion foil and said facing cathode foil by said concaves and convexes, after winding said anode chemical conversion foil and said facing cathode foil.

6. The method of manufacturing an electrolytic capacitor according to claim 5, wherein said first solid electrolyte layer has a thickness of not less than 0.1 μm.

7. The method of manufacturing an electrolytic capacitor according to claim 5, wherein a ratio of a depth of a concave to a thickness of a convex in said concaves and convexes is not less than 0.05 and not more than 0.9.

8. The method of manufacturing an electrolytic capacitor according to claim 5, wherein said concaves and convexes are formed all over said main surface of said first solid electrolyte layer.
